(19) United States
(12) Patent Application Publication
(10) Pub. No.: US 2002/0151995 A1
(43) Pub. Date: Oct. 17, 2002

(54) Distributed audio system for the capture, conditioning and delivery of sound

(76) Inventors: Joel A. Jorgenson, Fargo, ND (US); John W. McCullough, Austin, TX (US); William J. Steingrandt, Punta Gorda, FL (US)

Correspondence Address: John Veldhuis-Kroeze, WESTMAN CHAMPLIN & KELLY, Suite 1600 - International Centre, 900 South Second Avenue, Minneapolis, MN, 55402-3319, US

(21) Appl. No.: 09/834,011

(22) Filed: Apr. 12, 2001

(51) Int. Cl. G06F 17/00; H04R 29/00

(52) U.S. Cl. 700/94; 381/56

(57) ABSTRACT

A method of the invention, embodied for example as computer executable instructions stored on a computer readable medium and executed on a personal computer, includes obtaining a first filter profile for an audio conditioning unit of a sound conditioning system. The first filter profile corresponds to an audiogram of a user of the system. Sound data corresponding to audio to be played is obtained and filtered using the first filter profile. The filtered sound data is played for the user of the sound conditioning system. The user can adjust the first filter profile for current hearing capabilities and specific sound environments without the aid of an audiologist. Multiple filter profiles can be uploaded from the personal computer to an audio conditioning unit of a listening conditioning system. The listening conditioning system includes multiple effective displacement compression units which capture sound at multiple sources and wirelessly transmit raw sound data to the audio conditioning unit, thus providing multi-channel capabilities. Filtered sound data is transmitted to one or more audio delivery components.

The present invention was made with government support under Grant No. EPS-9874802, awarded by the NSF. The U.S. Government has certain rights to the invention.

### BACKGROUND OF THE INVENTION

The present invention relates to hearing aids and other listening conditioning systems. More particularly, the present invention relates to a listening conditioning system and a method of establishing and updating filter profiles for the listening conditioning system to accommodate for changes in the hearing of the user of the system and/or for new sound environments.

Hearing aids and other listening conditioning systems are well known in the art. Many of these devices or systems utilize a filter profile established by an audiologist to filter sound in order to compensate for the specific hearing loss, capabilities or preferences of the user. Some of these systems allow the user to select from multiple different filter profiles for different sound environments to which the user may be exposed. The filter profile(s) are determined after the user of the system takes an audiogram test under the supervision of the audiologist or a technician. This is a time consuming process, which may or may not require the user of the listening conditioning system to leave components of the system with the audiologist or the manufacturer for programming.

If the user of the listening conditioning system wishes to establish a new filter profile for a sound environment not previously addressed by the available filter profiles, he or she may again have to return to the audiologist for help in doing so. This is again time consuming and potentially costly. Some prior art systems have allowed the user to adjust some of the operational parameters (volume, etc) of the filter profiles. Prior art systems which allow the user to adjust the operational parameters of the filter profiles may not do so based upon an audiogram. Further, these systems may not provide the user a mechanism for evaluating and fine tuning these adjustments prior to use in a particular sound environment.

People frequently experience changes in hearing capability or preference caused by temporary physical ailments such as colds. These changes in hearing capability can also be more permanent in nature. When the user of a listening conditioning system configured by an audiologist experiences a change in hearing, the corresponding necessary adjustment of the filter profile(s) again typically requires the aid of an audiologist. Once again, this can be a time consuming and expensive process.

Many hearing aids and sound conditioning systems suffer from significant signal-to-noise ratio problems due to noisy sound environments and attenuation of the sound waves as they travel from the source of sound to the microphone. Further, when used in environments in which more than one primary source of sound is important, these systems have limitations since regardless of where the microphone is positioned, at least one source of sound will likely not be positioned close enough to the microphone to avoid significant loss of the audible signal. These and other problems with many prior art listening conditioning systems limit their usefulness in some manner.

### SUMMARY OF THE INVENTION

A method of the invention, embodied for example as computer executable instructions stored on a computer readable medium and executed on a personal computer, includes obtaining a first filter profile for an audio conditioning unit of a sound conditioning system. The first filter profile corresponds to an audiogram of a user of the system. Sound data corresponding to audio to be played is obtained and filtered using the first filter profile. The filtered sound data is played for the user of the sound conditioning system. The user can adjust the first filter profile for current hearing capabilities and specific sound environments without the aid of an audiologist. Multiple filter profiles can be uploaded from the personal computer to an audio conditioning unit of a listening conditioning system. The listening conditioning system includes multiple effective displacement compression units which capture sound at multiple sources and wirelessly transmit raw sound data to the audio conditioning unit, thus providing multi-channel capabilities. Filtered sound data is transmitted to one or more audio delivery components.

### BRIEF DESCRIPTION OF THE DRAWINGS

FIG. 1 is a diagrammatic representation of a computer operating environment in which embodiments of the invention are utilized.

FIGS. 2, 4 and 5 are diagrammatic representations of a graphical user interface of an application program in accordance with embodiments of the present invention.

FIGS. 3 and 6-9 are flow diagrams illustrating methods of the present invention which can be embodied as computer executable instructions stored on a computer readable medium.

FIG. 10 is a block diagram illustrating a sound or listening conditioning system in accordance with embodiments of the invention.

FIG. 11 is a block diagram illustrating in greater detail embodiments of the effective displacement units of the listening conditioning system shown in FIG. 10.

FIG. 12 is a block diagram illustrating in greater detail embodiments of the audio conditioning unit of the listening conditioning system shown in FIG. 10.

FIG. 13 is a block diagram illustrating in greater detail embodiments of the audio delivery components of the listening conditioning system shown in FIG. 10.

### DETAILED DESCRIPTION OF ILLUSTRATIVE EMBODIMENTS

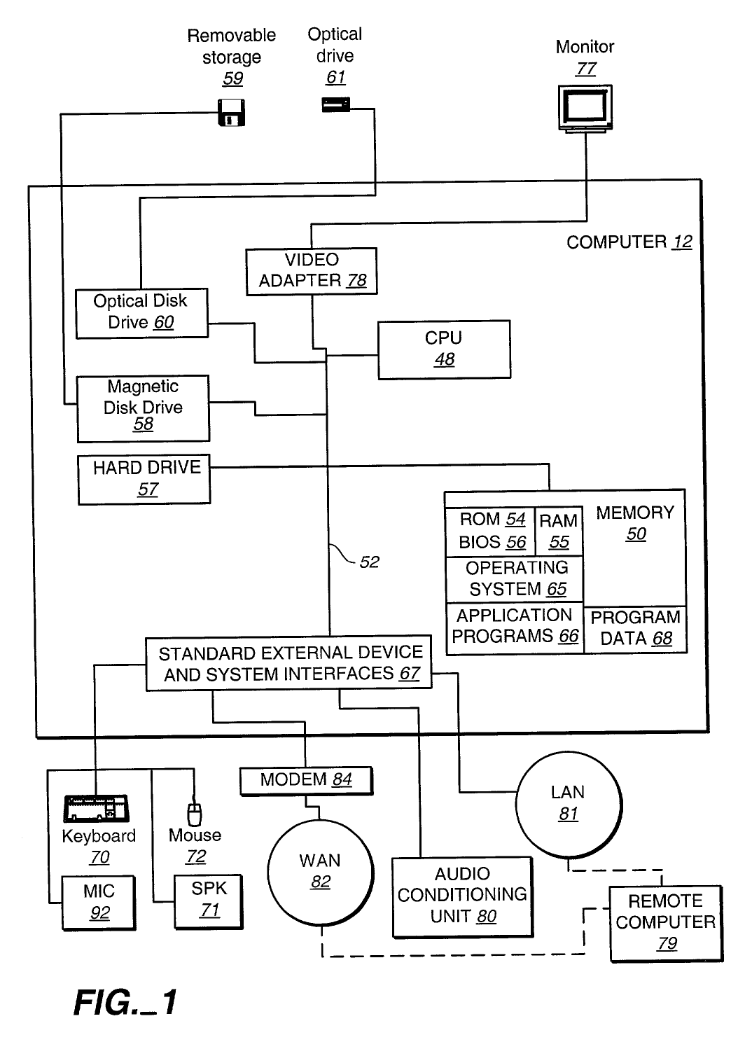

FIG. 1 and the related discussion are intended to provide a brief, general description of a suitable desktop computer 12 in which portions of the invention may be implemented. Although not required, the invention will be described, at least in part, in the general context of computer-executable instructions such as an application program being executed by a personal computer 12. The user of the listening conditioning system of the present invention can utilize the personal computer to run an application program which develops filter profiles, tailored to the current hearing abilities of the user for multiple sound environments, which can be uploaded to the listening conditioning system. The application program and associated methods, as well as the listening conditioning system, are discussed below in greater detail.

With reference to FIG. 1, an exemplary system for implementing personal computer 12 (or other similar computing devices such as hand-held or laptop computers) includes a processing unit 48, a system memory 50, and a system bus 52 that couples various system components including the system memory 50 to the processing unit 48. The system memory 50 typically includes read only memory (ROM) 54 and random access memory (RAM) 55. A basic input/output system (BIOS) 56, which helps to transfer information between elements within the computer 12, can be stored in ROM 54. The computer 12 further includes a hard disk drive 57 for reading from and writing to a hard disk (not shown), a magnetic disk drive 58 for reading from or writing to removable magnetic disk 59, and an optical disk drive 60 for reading from or writing to a removable optical disk 61 such as a CD ROM or other optical media. The drives and the associated computer-readable media provide nonvolatile storage of computer readable instructions, data structures, program modules and other data for computer 12. It should be appreciated by those skilled in the art that other types of computer readable media, which can store data that is accessible by a computer, can be used in conjunction with computer 12 in implementing the invention.

A number of program modules may be stored on the hard disk 57, magnetic disk 59, optical disk 61, ROM 54 or RAM 55, including an operating system 65, one or more application programs 66 and program data 68. A user may enter commands and information into the computer 12 through input devices such as a keyboard 70, pointing device 72, and microphone 92. These and other input devices are often connected to the processing unit 48 through a standard external device or system interface 67. Interface 67 can be, for example, a serial port interface. Interface 67 can also be other types of external device or system interfaces such as a sound card, a modem, a network card, a parallel port, a game port or a universal serial bus (USB) for example. A monitor 77 or other type of display device is also connected to the system bus 52 via an interface, such as a video card or adapter 78. In addition to the monitor 77, computers may typically include other peripheral output devices such as speakers 71 and printers. In embodiments of the invention, computer 12 is coupleable through a serial, USB or other port to audio conditioning unit 80 of a listening conditioning system for the purpose of uploading sound conditioning filter profiles to the audio conditioning unit. This will be described below in greater detail.

Computer 12 may operate in a networked environment using logic connections to one or more remote computers such as a remote computer 79. The remote computer 79 may be another personal computer, a server, a router, a network PC, a peer device or other network node. The logic connections depicted in FIG. 1 include a local area network (LAN) 81 and a wide area network (WAN) 82. Such networking environments are commonplace in offices, enterprise-wide computer network intranets and the Internet, and any of these types of networks can be used to transfer data between computers 12 and 79 as will be described below in greater detail.

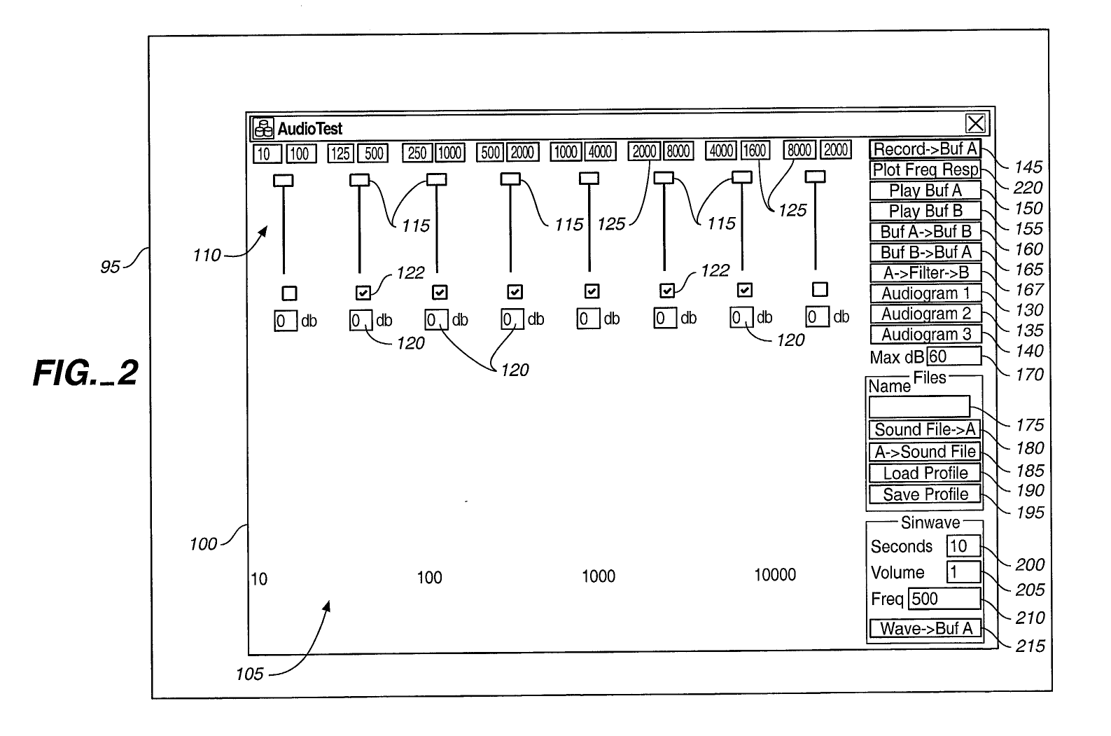

FIG. 2 is a diagrammatic illustration of a graphical user interface (GUI) 100 of an application program 66 of the present invention. GUI 100 is displayed on computer monitor 77 in conjunction with the operating system GUI 95. For discussion purposes, inputs, outputs and other features described with reference to GUI 100 should be understood to be discussions of inputs or outputs of application program 66 of the present invention. Further, other features of application program 66 which are not specifically illustrated in GUI 100 are discussed as well.

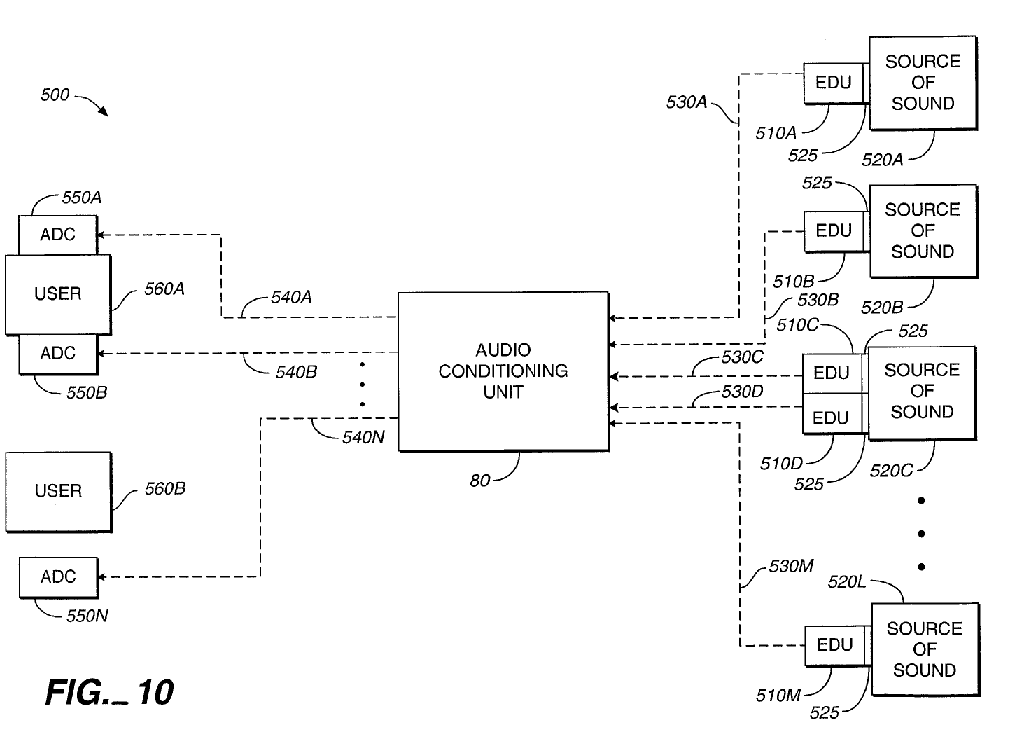

Application program 66 is stored on a computer readable medium containing computer executable instructions for performing various steps in methods of the present invention for creating multiple filter profiles which can be uploaded to an audio conditioning unit 80 of a sound or listening sound conditioning system 500 (FIG. 10). Application program 66 runs on computer 12, so that the user of the listening conditioning system can update or change the filter profiles without the aid of an audiologist as is typically required in the prior art. This is very useful in allowing the user of the listening conditioning system to compensate for temporary changes in hearing, for example caused by colds, allergies or other physical conditions. Also, application program 66 allows the user of the listening conditioning system to create new filter profiles for different sound environments to which the user may be exposed.

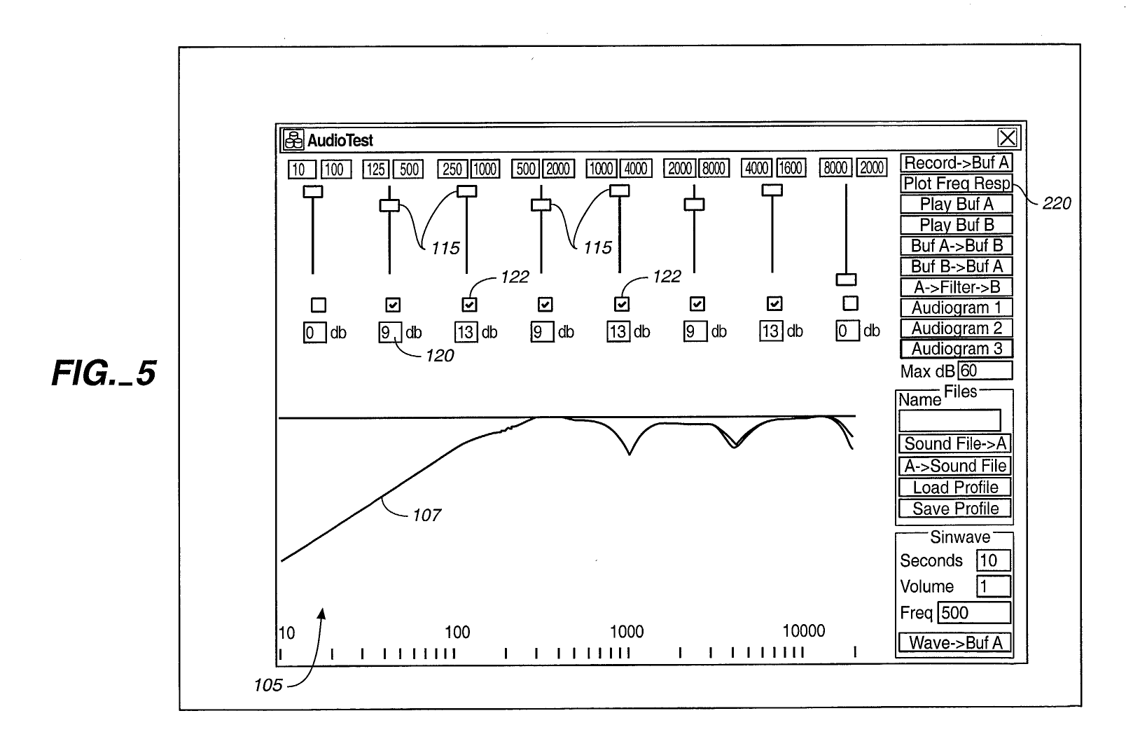

GUI 100 includes a filter response plot display area 105, which is used to display a frequency response curve (see also FIG. 5) corresponding to a filter profile generated by application program 66 for the user of the listening conditioning system. Also provided by GUI 100 of application program 66 are filter response manipulation inputs 110, which are used to control or change the frequency response of a current filter profile which was loaded into or automatically generated by program 66. As illustrated, filter response manipulation inputs 110 include multiple slide scale inputs 115 and corresponding direct gain numerical readouts 120. In some embodiments, each slide scale input 115 and each corresponding direct gain numerical readout 120 can be used to manipulate the gain of a frequency range, of the filter profile, defined by the corner frequencies illustrated in corner frequency numerical inputs 125. In other embodiments, only the slide scale inputs 115 or only the readouts 120 can be used to change the gain values, but not both. The corner frequency numerical inputs 125 for each frequency range are illustrated as being those inputs 125 which are positioned immediately adjacent either side of the corresponding slide scale input 115 and direct gain numerical readout 120. Generally, the corner frequencies are set to the default values illustrated in FIG. 2, which conform to normal audiogram settings. However, the corner frequencies can be changed by the user if desired by entering different corner frequency values into inputs 125 using a pointing device and keyboard. Check box inputs 122 are selected to enable the various filter frequency ranges.

Also provided by GUI 100 are audiogram input controls 130, 135 and 140. Audiogram 1 input control 130 can be selected by a user of the personal computer, causing application program 66 to conduct a standard audiogram test of the hearing of the user. Using speakers 71 (FIG. 1), application program 66 and personal computer 12 generate a series of tones at differing frequencies with linearly increasing volumes. When the volume of a tone increases to the point that the user can audibly detect the tone, the user provides an input to personal computer 12. The input can be, for example, a press of a key on keyboard 70.

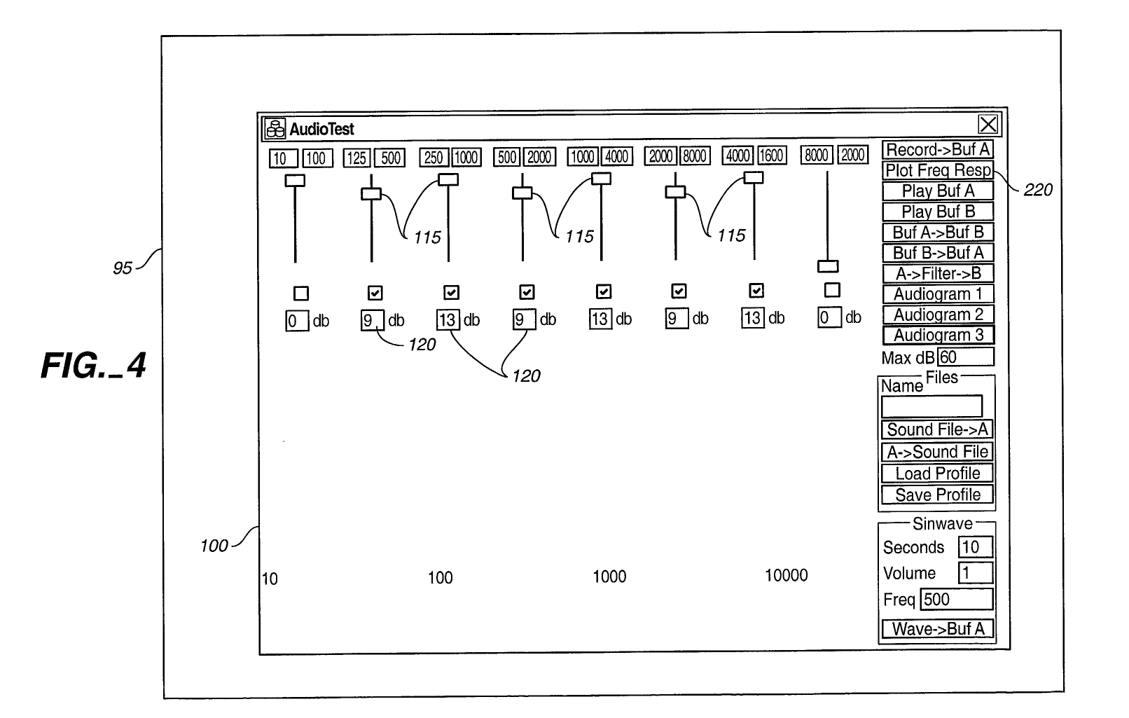

At the end of the audiogram test, application program 66 automatically sets gain values for the different frequency ranges of the filter profile. This can be seen for example in FIG. 4 in which slide scale inputs 115 and direct gain numerical readouts 120 reflect relative gain differences between the frequency ranges of the filter profile. The gain differences between the various frequency ranges in the filter profile are such that when filtering sound, the user of the listening conditioning system will hear sound in each of the frequency ranges at substantially equal volumes (assuming the sound of each frequency range is generated at a substantially equal volume) . In other words, the filter profile generated by application program 66 attenuates the gain more in the frequency ranges in which the user's hearing is best such that when filtered the user will hear the filtered sound substantially equally well in all of the frequency ranges.

Audiogram 3 input 140 causes application program 66 to function similarly, but the sequence of tones provided by the personal computer and the speakers is not linearly increased in volume as was the case with the Audiogram 1 input 130. A binary search pattern sequency is used. In this manner, Audiogram 3 input 140 provides for a faster audiogram test of the user's hearing. Audiogram 2 input 135 can be selected by the user after the application of an the Audiogram 1 or Audiogram 3 tests. Selection of the Audiogram 2 input 135 causes a series of tones to be filtered by the generated filter profile and played through the speakers. Thus a preliminary check of the filter profile generated using the Audiogram 1 or Audiogram 3 inputs can be conducted, allowing the user to verify that the volume of each tone sounds approximately equal.

Also provided by GUI 100 are sound file manipulation inputs 145, 150, 155, 160, 165, 167 and 170. When selected, Record Buffer A input control 145 causes application program 66 to record sound data corresponding to audio to be played for the user of the sound conditioning system. The sound data can be representative of a variety of different sound environments to which the user of the listening conditioning system (FIG. 10) will be exposed. The sound data recorded by application program 66 can be obtained from a variety of sources. For example, the sound data can be obtained by application program 66 from microphone 92, from data stored on a magnetic or optical disc, from data at the sound card used to drive the speakers, from data downloaded over a computer network such as the Internet, or from other sources. The recorded sound data is temporarily stored in a memory location referred to as “Buffer A”.

Play Buf A input 150, when selected, causes application program 66 to play the recorded and stored sound data over the speakers of the personal computer. Play Buf B input 155 causes the computer to play sound data stored in a second memory location known as “Buffer B” over the speakers. Buffer data transfer input control 160 causes sound data stored in the memory location referred to as Buffer A to be transferred to the memory location referred to as Buffer B. Input 165 causes sound data stored in memory location Buffer B to be transferred to the memory location Buffer A.

Input 167, when selected, causes the sound data stored in memory location Buffer A to be filtered using the current filter profile (represented by the position of slide scales 115 and the numerical gain values shown in direct gain inputs 120), with the filtered results stored in memory location Buffer B. Thus, sound data representing a particular sound environment can be recorded from an external source and stored in Buffer A, filtered using the filter profile generated by application program 66, and the filtered sound data stored in the memory location Buffer B. Then, using one or more of inputs 150, 155, 160 and 165, the filtered sound data can be transferred between memory locations and/or ultimately played over the speakers of the personal computer. Thus, the user of the personal computer and of the listening conditioning system can test the generated filter profile on the recorded sound data to determine whether the filter profile is optimized for the particular sound environment and/or for current hearing loss levels. Maximum decibel input 170 sets the maximum volume of the sound data played back over the speakers of the personal computer.

Also provided by GUI 100 are file manipulation inputs 175, 180, 185, 190 and 195. Selecting input 180 causes a sound file having a name, which is input into alphanumeric input box 175, to be loaded into the memory location Buffer A from other more permanent memory locations. Selection of input 185 causes sound file data in memory location Buffer A to be stored in a sound file having a user determined name. Thus, using inputs 180 and 185, sound data recorded from other sources can be stored in memory of the personal computer and can be later retrieved for use in analysis of a generated filter profile. Generated profiles can be saved to memory of the computer using input 195 and alphanumeric input 175, while saved profiles can be loaded to application program 66 using input 190. Thereby, multiple filter profiles corresponding to different sound environments and/or hearing conditions of the user can be saved in the memory of personal computer 12 for uploading to the listening conditioning system.

Sinewave control inputs 200, 205 and 210 respectively allow the duration, volume and frequency of a generated tone to be controlled by the user. The Sinewave or tone established by the user through manipulation of inputs 200, 205 and 210 can be transferred to memory location Buffer A using transfer input 215. Subsequently, the tone can be filtered using the currently loaded or established filter profile (for example using input 167 discussed above) and played back to the user for analysis of the filter profile. The gain of individual frequency ranges of the filter profile can then be adjusted using tailored tones to facilitate feedback or testing.

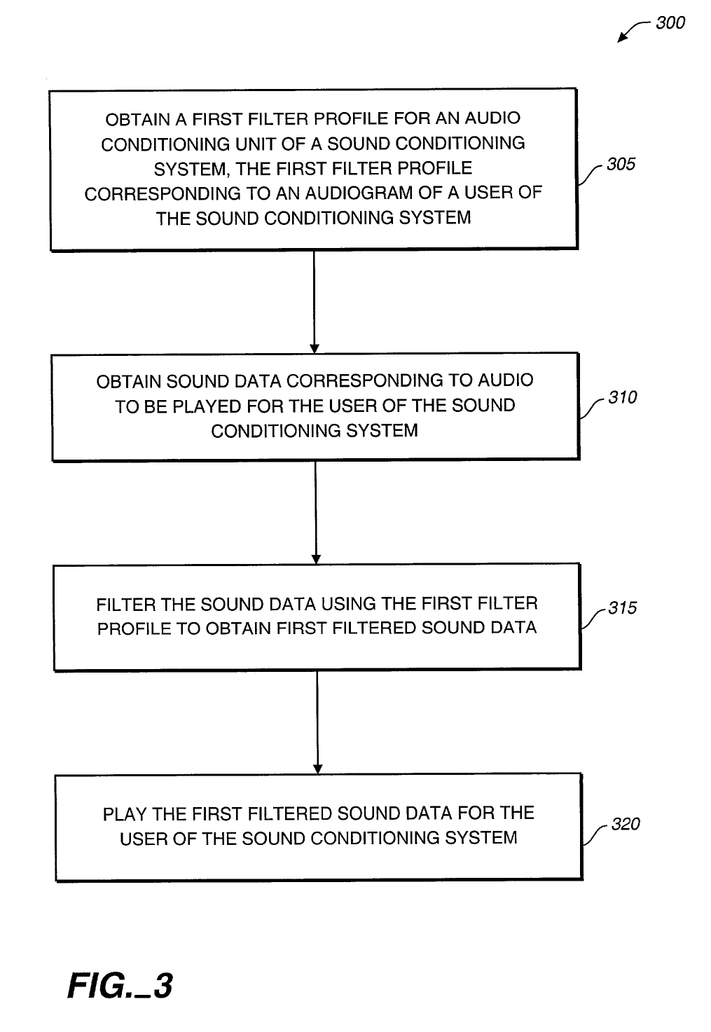

Shown in FIG. 3 is a flow diagram 300 demonstrating a method in accordance with the present invention. Although described here as method steps, the invention also includes computer readable medium containing computer executable instructions for performing the steps of the method. As shown at block 305, the method includes the step of obtaining a first filter profile for an audio conditioning unit of a sound conditioning system, with the first filter profile corresponding to an audiogram of a user of the sound conditioning system. In some embodiments, step 305 of obtaining the first filter profile for the audio conditioning unit includes retrieving the first filter profile from memory of computer 12. For example, referring back to FIG. 2, this can be accomplished by selecting the load profile input 190. In this instance, the first filter profile can correspond to a filter profile established by an audiologist after conducting an audiogram test of the user's hearing, or can be a filter profile previously established by the user without the direct aid of an audiologist.

Referring for the moment to the flow diagram 450 shown in FIG. 9, step 305 (FIG. 3) of obtaining the first filter profile for an audio conditioning unit of a sound conditioning system can include the step shown at block 455 of testing the hearing of the user of the sound conditioning system to establish an audiogram for the user, followed by the step shown at block 460 of determining the first filter profile from the audiogram. As shown in FIG. 2, application program 66 can perform an audiogram-type test of the user's hearing. As discussed above, the audiogram-type test is initiated by selecting either of inputs 130 or 140. Once the first filter profile for the user is obtained, gain values for the various frequency ranges of the filter profile are automatically set. This can be seen with the repositioning of slide scale inputs 115 and the differing direct gain numerical values in readouts 120 as shown in FIG. 4. Further, by selecting plot frequency response input 220 a frequency response 107 is plotted in plot display area 105 as can be seen in FIG. 5.

Referring back to FIG. 3, the method illustrated in flow diagram 300 next includes the step shown at block 310 of obtaining sound data corresponding to audio to be played for the user of the sound conditioning system. As discussed previously, the sound data corresponding to audio to be played for the user of the sound conditioning system can be obtained from a wide variety of sources. For example, the sound data can be retrieved from memory using input 180 (FIG. 2). The sound data can also be retrieved from internal hardware of computer 12. For example, sound data can be retrieved from the sound card or sound driver of the computer. The sound data can also be retrieved from microphone 92 of computer 12, or downloaded from a computer network such as the Internet. Generally, the sound data, and the corresponding audio to be played for the user of the sound conditioning system, represents a sound environment to which the user of the listening conditioning system will be exposed while using the conditioning system. For example, the audio can be various types of music, noise environments, sporting events, or any of a wide variety of other sound audio.

The method of the invention shown in flow diagram 300 also includes the step shown at block 315 of filtering the sound data using the first filter profile to obtain first filtered sound data. Using application program 66, this can be performed for example by placing the sound data in Buffer A and selecting input 167 to filter the sound data in Buffer A, placing the filtered sound data in Buffer B.

The method next includes the step shown at block 320 of playing the first filtered sound data for the user of the sound conditioning system. Referring again to FIG. 2, this can be implemented by application program 66 upon the user selecting the appropriate input (for example inputs 150 or 155) to play the filtered sound data. When the filtered sound data is played by personal computer 12, the user of the personal computer and the listening conditioning system can make a determination of whether the filtering afforded by the filter profile is appropriate for the particular sound environment and/or the user's current hearing capabilities.

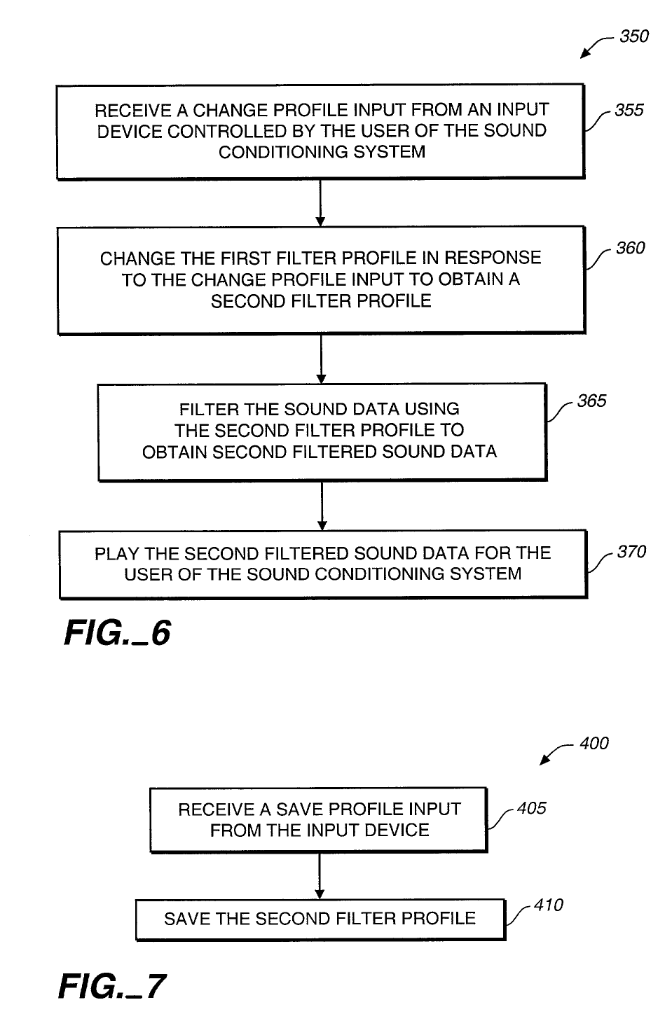

The present invention includes not only the ability to generate and/or test filter profiles on a variety of different types of audio, but also the ability for the user to adjust the filter profile to accommodate his or her specific needs, without requiring an audiologist's aid. using personal computer 12, the user of the listening conditioning system can adjust filter profiles to compensate for changes in hearing resulting from a cold, for example. Similarly, the user of the listening conditioning system can utilize the personal computer to adjust filter profiles for his or her preferences in a variety of different sound environments. The various adjusted filter profiles can be saved in memory, and multiple different filter profiles can be uploaded to the listening conditioning system where the user selects which filter profile to use in a particular sound environment. These aspects of the present invention are further illustrated in the additional methods steps shown in the flow diagram 350 of FIG. 6.

As shown in FIG. 6, in some embodiments the methods of the present invention further include the step shown at block 355 of receiving a change profile input from an input device controlled by the user of the sound conditioning system. As shown at block 360 in FIG. 6, the application program changes the first filter profile in response to the change profile input. Referring to FIGS. 2, 4 and 5, this input from the user can be, for example, in the form of clicking on and dragging one of slide scale inputs 115 to adjust the gain of a particular frequency range of the filter profile. Moving one of slide scale inputs 115 results in an automatic change of the gain value in the corresponding readout 120. In the alternative, the user of personal computer can in some embodiments change the gain for a particular frequency range simply by clicking on one of readouts 120 and using the keyboard to type in a new gain value. When all desired changes to the filter profile are completed, a second filter profile is obtained.

A next step in the method shown in FIG. 6 includes filtering the sound data using the second filter profile to obtain second filtered sound data. This step is shown at block 365 and can be implemented, for example, using input 167 (FIG. 2). Next, as shown at block 370, the method includes playing the second filtered sound data for the user of the sound conditioning system. This step can be implemented, for example, using the play buffer inputs 150 and 155 shown in FIG. 2. Playing the second filtered sound data for the user of the conditioning system allows the user to determine whether the second filter profile is an improvement over the first filter profile for a particular sound environment and/or for the user's current hearing capabilities.

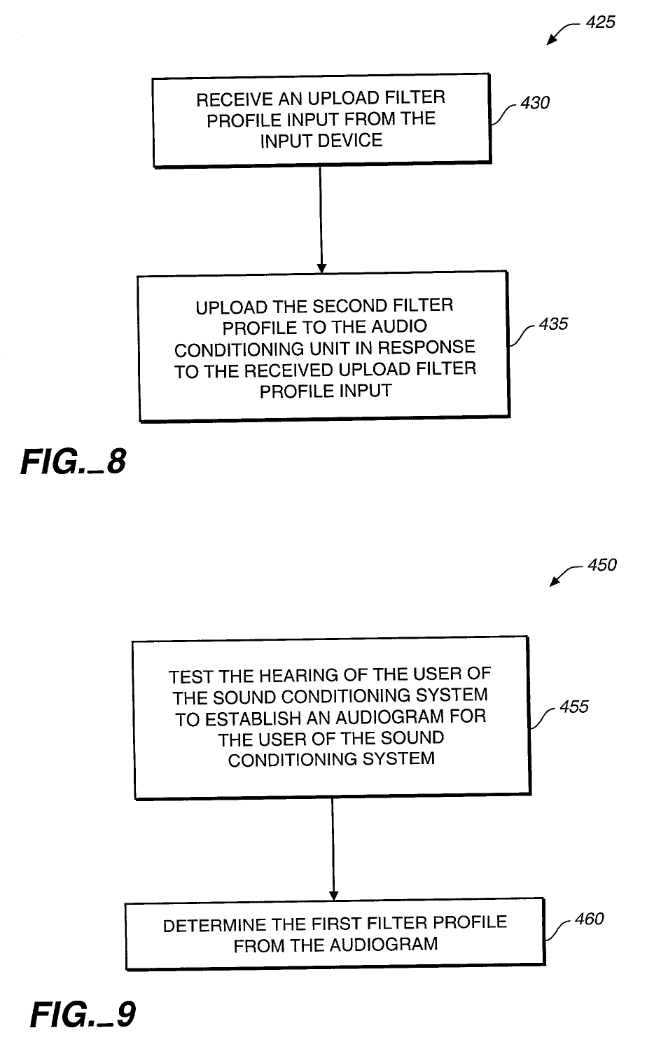

FIGS. 7 and 8 illustrate further steps in embodiments of the methods of the present invention. As illustrated in the flow diagram 400 of FIG. 7, if the user of the listening conditioning system determines that the second filter profile is an improvement for a particular sound environment or for the current hearing capabilities of the user, he or she provides a save profile input to the application program. For example, using the keyboard or a pointing device, a name for the second filter profile can be entered in file name input 175, and save profile input 195 can be selected to cause the second filter profile to be saved to the memory of computer 12. These steps are shown in blocks 405 and 410 of FIG. 7.

Once one or more (typically multiple) filter profiles are saved in the memory of computer 12, the user of the personal computer provides an input command to upload the filter profile(s) to an audio conditioning unit of the user's listening conditioning system. Upon the application program receiving the upload filter profile input from the input device (block 430 shown in flow diagram 425 of FIG. 8), the second filter profile is uploaded to the audio conditioning unit in response (block 435). In this manner, the audio conditioning unit of the user's listening conditioning system can be updated in the convenience of the user's home. Neither a trip to an audiologist, nor the burden and task of returning the listening conditioning system to the manufacturer, are required.

FIG. 10 is a block diagram illustrating embodiments of listening conditioning system 500 of the present invention. As shown, listening conditioning system 500 includes multiple effective displacement compression units (EDUs) 510A-510M, audio conditioning unit 80 and multiple audio delivery components 550A-550N. Each EDU 510 is positionable proximate a sound source 520 (sound sources 520A-520L are shown), and can include an attachment mechanism 525 which attaches the EDU to the desired sound source. In some embodiments, the attachment mechanism 525 is a lapel attachment mechanism which is adapted to attach the EDU to the clothing of a speaker.

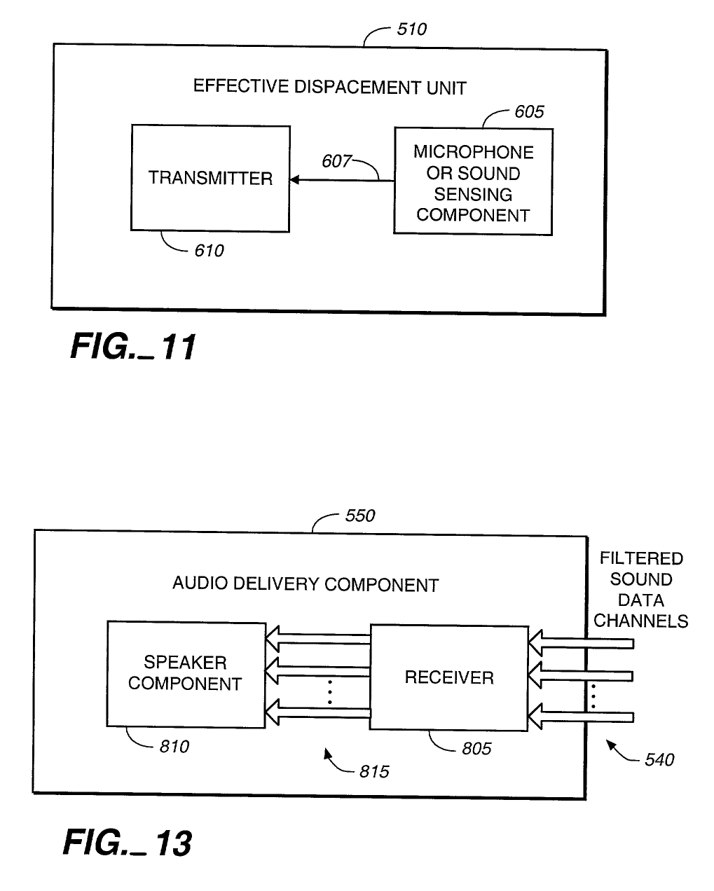

Referring for the moment to the block diagram of FIG. 11, shown is a more particular embodiment of an EDU 510 of system 500 the present invention. As can be seen in FIG. 11, each EDU 510 includes a microphone or sound sensing component 605 which coverts sound from the proximate source 520 into electrical signals 607. Each EDU 510 also includes a transmitter 610, coupled to the sound sensing component 605, which receives the electrical signals and in response transmits electromagnetic signals 530 (signals 530A-530M are shown in FIG. 10) indicative of sound from the proximate source 520 sensed by the sound sensing component. By including multiple EDUs 510 in system 500, multi-channeled wireless raw sound delivery to audio conditioning unit 80 is accomplished.

Each channel 530 can correspond to an EDU proximate a different source of sound. However, in some embodiments, multiple EDUs are positioned proximate the same source of sound in order to capture the sound from that source in a stereo format. For example, EDUs 510C and 510D are each positioned proximate source 520C. Electromagnetic signals or channels 530C and 530D can thereby provide stereo sound from source 520C. The electromagnetic signals transmitted by EDUs 510 can be wireless format signals.

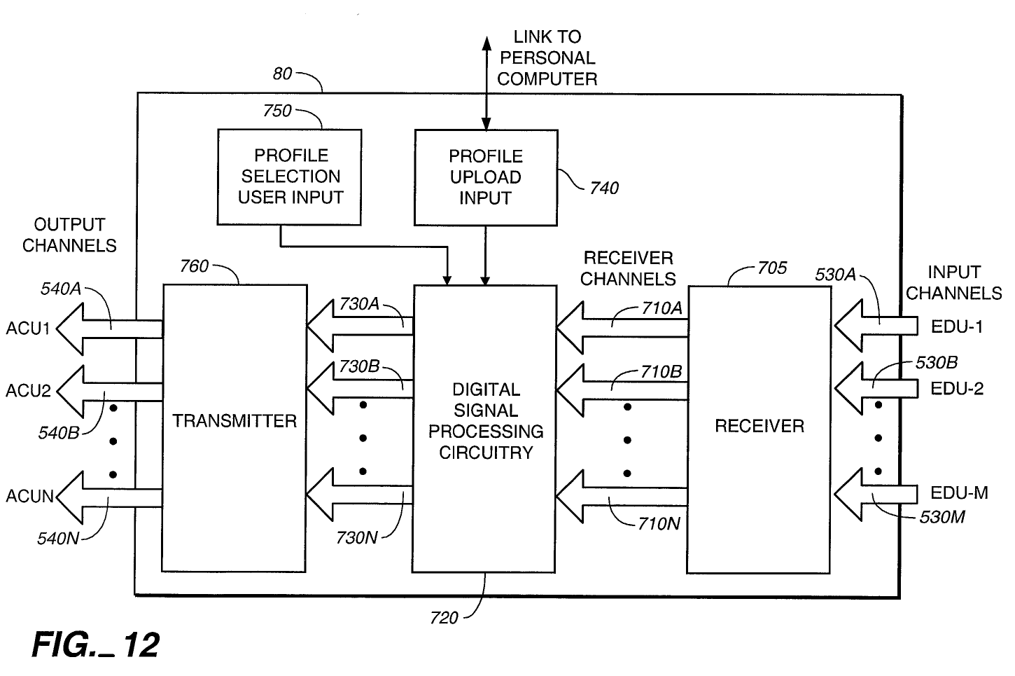

As discussed above, system 500 also includes audio conditioning unit 80. Audio conditioning unit 80 is also illustrated in FIG. 12 in greater detail. As can be seen in FIG. 12, audio conditioning unit 80 includes a receiver 705 which receives the electromagnetic signals or channels EDU-1 through EDU-M (530A-530N) transmitted by the EDUs 510. Receiver 705 converts the electromagnetic signals into digital sound data channels 710 (channels 710A-710N are shown) . It will be understood by those of skill in the signal processing art that the number of channels M provided to receiver 705 need not be the same as the number of output channels N provided by the receiver. Although several stages of signal processing illustrated in FIG. 12 are shown to include N channels, it is to be understood that the number of channels provided to any stage of the signal processing circuitry need not be the same as the number of channels provided as an output from that stage.

As is also illustrated in FIG. 12, audio conditioning unit 80 further includes digital signal processing circuitry 720 coupled to the multiple receiver output channels 710. The digital signal processing circuitry 720 filters the digital sound data from each receiver output channel 710 using a filter profile to obtain filtered digital sound data or data channels 730A-730N.

A profile upload input 740 is included in audio conditioning unit 80 and is configured to be coupled to personal computer 12. Profile upload input 740 receives one or more (typically multiple) available filter profiles from the personal computer for use in different sound environments. As such, each of the multiple available filter profiles uploaded to audio conditioning unit 80 through input 740 corresponds to user preferences or to an audiogram of a user of the listening conditioning system and to a particular sound environment. A profile selection user input 750 is also included in audio conditioning unit 80. The user input 750 provides a mechanism for the user of the listening conditioning system to select one of the filter profiles from the multiple available filter profiles. Thus, the user can change the filter profile used to filter sound data based upon the current sound environment to which he or she is exposed. In some embodiments, different filter profiles can be selected to filter different sound data channels 710 containing sound data from sources in differing sound environments.

A transmitter 760 of audio conditioning unit 80 is coupled to digital signal processing circuitry 720 and is configured to transmit filtered sound data from each of the plurality of receiver channels. Like EDUs 510, transmitter 760 is adapted for wireless transmission of output channels ACUL-ACUN (540A-540N). In the particular embodiment shown in FIG. 12. transmitter 760 transmits filtered sound data from each of the plurality of receiver channels by transmitting filtered digital sound data 730. Sound data 730 can be transmitted in any of a wide range of formats.

Referring back to FIG. 10, listening conditioning system 500 also includes at least one audio delivery component (ADC) 550. As illustrated, listening conditioning system 500 includes N ADCs 550A-550N. However, this need not be the case. As shown in FIG. 13, each ADC 550 includes a receiver 805 and a speaker component 810. The receiver receives the filtered sound data 540 from multiple of the ACU output channels 540A-540N, providing ADC receiver output channel data 815 in response. Speaker component 810 converts the received and filtered sound data 815 into sound for a user 560 (users 560A and 560B are shown in FIG. 10).

In some embodiments of the listening conditioning system 500 of the present invention, a left audio delivery component and a right audio delivery component are respectively positionable proximate the left and right ears of a user of the listening conditioning system. For example, ADC 550A and ADC 550B can be left and right ADCs positionable proximate left and right ears of user 560A. In these embodiments, audio conditioning unit 80 can be configured to transmit a first portion of the filtered sound data, corresponding to a first portion of the plurality of receiver channels 710 or output channels 540, to the left conditioning unit, while it transmits a second portion of the filtered sound data corresponding to a second portion of the multiple receiver or output channels to the right ADC. Thereby, stereo or directional sound delivery is provided to the user of the listening conditioning system. In some embodiments, the audio conditioning unit 80 is configured such that sound data corresponding to different ones of the multiple receiver channels 710 (or corresponding output channels 540) is filtered by the digital signal processor 720 using different ones of the plurality of available filter profiles. Therefore, if different sources of sound 520 are positioned in or represent different sound environments, different filter profiles can be used to filter sound data from these different sources.

ADCs 550 can include a universal audio connection with delivery to standard output jacks so that the media used is user optional for different sound environments. A variety of different embodiments of ADC 550 can be utilized in the present invention. For example, at least one of ADCs 550 can include a telephone or cell phone adapted to receive filtered sound data from audio conditioning unit 80. In another embodiment, at least one ADC 550 includes a stereo receiver adapted to receive filtered sound data from audio conditioning unit 80 and to play the sound data over speakers connected to the stereo receiver. In yet other embodiments, at least one ADC 550 is a hearing aid device coupleable to the ear of the user. Other embodiments include over ear head phones, in ear head phones, or other sound delivering devices.

In the system disclosed, by the placement of the sound sensing component and electromagnetic propagation (as opposed to wave propagation of the sound), the effective displacement between sound source and sound receiver is compressed. For example when capture is 6″ from the sound source rather than 4′(8×) the sound level is improved by 64 times(36 db). This is audio quality that the conditioning unit 80 need not supply. Furthermore, ambient signal-to-noise is improved by the same factor. Typical sound environments include dining in a restaurant and riding in a car, each of which present significant noise problems.

Referring to the environments above, in an example use of system 500, each of multiple speakers (sound sources 520) is fitted with a wireless lapel microphone, each with a corresponding receiver channel in the conditioning unit. Directional orientation can be preserved by (color) coding the microphones. The audio conditioning unit delivers the captured sound to the left, balanced, or right ears of the user depending on the relative directions of the speaker(s) as set up by the user.

Although the present invention has been described with reference to preferred embodiments, workers skilled in the art will recognize that changes may be made in form and detail without departing from the spirit and scope of the invention.

What is claimed is:

1. A computer readable medium containing computer executable instructions for performing the steps of:
obtaining a first filter profile for an audio conditioning unit of a sound conditioning system, the first filter profile corresponding to an audiogram of a user of the sound conditioning system;
obtaining sound data corresponding to audio to be played for the user of the sound conditioning system;
filtering the sound data using the first filter profile to obtain first filtered sound data; and
playing the first filtered sound data for the user of the sound conditioning system.

2. The computer readable medium of claim 1, and further containing computer executable instructions for performing the steps of:
receiving a change profile input from an input device controlled by the user of the sound conditioning system; and
changing the first filter profile in response to the change profile input to obtain a second filter profile;
filtering the sound data using the second filter profile to obtain second filtered sound data; and
playing the second filtered sound data for the user of the sound conditioning system.

3. The computer readable medium of claim 2, and further comprising computer executable instructions for performing the steps of:
receiving a save profile input from the input device; and
saving the second filter profile.

4. The computer readable medium of claim 3, and further comprising computer executable instructions for performing the steps of:
receiving an upload filter profile input from the input device; and
uploading the second filter profile to the audio conditioning unit in response to the received upload filter profile input.

5. The computer readable medium of claim 1, wherein the computer executable instructions for performing the step of obtaining the first filter profile further comprise computer executable instructions for retrieving the first filter profile from memory.

6. The computer readable medium of claim 1, wherein the computer executable instructions for performing the step of obtaining the first filter profile further comprise computer executable instructions for performing the steps of:
testing the hearing of the user of the sound conditioning system to establish an audiogram for the user of the sound conditioning system; and
determining the first filter profile from the audiogram.

7. The computer readable medium of claim 1, wherein the computer executable instructions for performing the step of obtaining sound data corresponding to audio to be played for the user of the sound conditioning system further comprises computer executable instructions for retrieving the sound data from a internal hardware of a computer executing the computer executable instructions.

8. The computer readable medium of claim 1, wherein the computer executable instructions for performing the step of obtaining sound data corresponding to audio to be played for the user of the sound conditioning system further comprises computer executable instructions for receiving the sound data from a microphone of a computer executing the computer executable instructions.

9. The computer readable medium of claim 1, wherein the computer executable instructions for performing the step of obtaining sound data corresponding to audio to be played for the user of the sound conditioning system further comprises computer executable instructions for downloading the sound data from a computer network.

10. The computer readable medium of claim 1, wherein the audio to be played for the user of the sound conditioning system represents a sound environment to which the user of the sound conditioning system will be exposed while using the sound conditioning system.

11. A listening conditioning system comprising:
a plurality of effective displacement compression units, wherein each effective displacement compression unit is positionable proximate a source of desired sound, each effective displacement compression unit comprising:
a sound sensing component which converts sound from the proximate source of desired sound into electrical signals; and
a transmitter coupled to the sound sensing component which receives the electrical signals and in response transmits electromagnetic signals indicative of sound from the proximate source sensed by the sound sensing component;
an audio conditioning unit comprising:
a receiver providing a plurality of receiver channels, wherein each receiver channel receives the electromagnetic signals transmitted by one of the plurality of effective displacement compression units and converts the electromagnetic signals into digital sound data;
digital signal processing circuitry coupled to the plurality of receiver channels, the digital signal processing circuitry filtering the digital sound data from each receiver channel using a filter profile to obtain filtered digital sound data;
a profile upload input configured to be coupled to a personal computer and to receive a plurality of available filter profiles from the personal computer, wherein each of the plurality of available filter profiles corresponds to user preferences or to an audiogram of a user of the listening conditioning system and to a particular sound environment;
a profile selection user input, wherein the user of the listening conditioning system uses the profile selection user input to select the filter profile from the plurality of available filter profiles; and
a transmitter coupled to the digital signal processing circuitry and configured to transmit filtered sound data from each of the plurality of receiver channels; and
at least one audio delivery component, wherein each audio delivery component comprises:
a receiver which receives the filtered sound data from multiple of the plurality of receiver channels; and
a speaker component which converts the received filtered sound data into sound.

12. The listening conditioning system of claim 11, wherein each of the plurality of effective displacement compression units further includes an attachment mechanism which attaches the effective displacement compression unit to the source of desired sound for the effective displacement compression unit.

13. The listening conditioning system of claim 11, wherein the at least one audio delivery component comprises a left audio delivery component and a right audio delivery component, respectively positionable proximate the left and right ears of the user of the listening conditioning system, the audio conditioning unit being configured to transmit a first portion of the filtered sound data corresponding to a first portion of the plurality of receiver channels to the left conditioning unit, and being configured to transmit a second portion of the filtered sound data corresponding to a second portion of the plurality of receiver channels to the right conditioning unit, thereby providing directional sound delivery to the user of the listening conditioning system.

14. The listening conditioning system of claim 11, wherein the audio conditioning unit is configured such that sound data corresponding to different ones of the plurality of receiver channels is filtered by the digital signal processor using different ones of the plurality of available filter profiles.

15. The listening conditioning system of claim 11, wherein the at least one audio delivery component includes an audio delivery component which is positionable proximate an ear of the user of the listening conditioning system.

16. The listening conditioning system of claim 11, wherein the at least one audio delivery component includes a phone.

17. The listening conditioning system of claim 11, wherein the at least one audio delivery component includes a stereo receiver.
